(19) United States
(12) Patent Application Publication
(10) Pub. No.: US 2004/0262851 A1
(43) Pub. Date: Dec. 30, 2004

(54) Rebuildable composite seal

(76) Inventors: Matt Tones, Palmyra, NY (US); Dan Reid, Kingwood, TX (US)

Correspondence Address: John M. Harrington, Kilpatrick Stockton LLP, 1001 West Fourth Street, Winston-Salem, NC, 27101, US

(21) Appl. No.: 10/877,351

(22) Filed: Jun. 25, 2004

Related U.S. Application Data
(60) Provisional application No. 60/482,549, filed on Jun. 25, 2003.

(51) Int. Cl. F16L 21/02

(52) U.S. Cl. 277/602

(57) ABSTRACT

A seal assembly is provided comprising an annular retainer comprising first and second flat circular faces and a central aperture extending through the center of said faces to allow fluid to flow therethrough, said annular retainer further comprising a pair of annular grooves formed in the first and second circular faces between said central aperture and the radially outer edge of the retainer, said grooves comprising a cross section including a width and a depth. A pair of annular seal elements disposed at least partially within the grooves and comprise cross sections including a width and a thickness wherein the thickness of the seal elements is greater than the depth of the grooves, and the seal elements are retained within the grooves with an adhesive.

### CROSS REFERENCE TO RELATED APPLICATIONS

The present application claims priority under 35 U.S.C. § 119(e) from U.S. Provisional Patent Application Ser. No. 60/482,549, filed Jun. 25, 2003, entitled “Rebuildable Composite Seal”, the disclosure of which is incorporated herein by reference.

### FIELD OF THE INVENTION

The present invention relates to a rebuildable seal assembly for sealing a connection between two pipe flanges, or the like. More particularly, the present invention relates to a composite seal comprising a retainer with grooves therein for securing a replaceable seal element.

### BACKGROUND OF THE INVENTION

Whenever two flanged pipe faces are to be connected, a seal or gasket must be provided in between the two faces so as to prevent leakage of the pipe contents in the area of the flanges. Several different types of seals have been employed for this purpose including solid metallic seals, metal/graphite or metal/polymer composite seals, elastomeric seals, as well as many other variations. Commonly the gasket is at least partly deformable or compressible to fill the area between the flanges and account for any irregularities in the flange faces thereby providing a sealing function when the flanges are tightened about the gasket.

One problem with prior art gaskets/seals is over or under-tightening of the flange bolts. The flange bolts must be tightened sufficiently to compress the seal to fill any voids between the two flange faces. If the seal is over-tightened, it can crack and fail. If the seal is under-tightened, the sealing function of the seal is lost. Under tightening is often the result of being overly cautious not to over-tighten the bolts. Therefore, it would be desirable to construct a seal that has built-in compression limiters such that the seal cannot be over-tightened.

Another problem associated with installing seals between flanges is the tendency of the seal element to twist or bind as it is slid between the flange faces. If the seal element twists or otherwise distorts, a proper seal may be unattainable or upon compression, the seal may fracture. It would, therefore, be desirable to provide a seal with means for preventing bending or twisting upon installation between two flanges.

Additionally, gaskets are subjected to radial force from the pressure within the flange assembly. The primary means for combating these forces is the friction between the gasket and the flange. If the radial force becomes too great, the seal may be forced out of the assembly. It would be beneficial, therefore, to provide additional radial support to the gasket to prevent deformation and leakage due to internal pressures.

Further, most prior art seals can only be effectively installed once. As discussed, when the flanges are tightened about a seal, the seal is deformed, often permanently. If a flange is to be disassembled, the old deformed seal must be replaced with a new seal to provide the necessary compressibility or resiliency. It would, therefore, be desirable to provide a seal that could be reused, or a seal assembly wherein a portion thereof, i.e. a retaining ring, could be reused thereby minimizing the non-reusable portion of the gasket.

Often, seals are required between pipe flanges comprising low strength flange materials such as cast iron, copper, or aluminum that operate at moderate to high system pressure. Additionally, applications often require low strength bolts such as ASTM A193 B8 Class 1, ASTM A307 Grade A or B, SAE Grade 2. With these low strength materials the compressive stresses necessary to seal other non-metallic or metallic gaskets will damage the equipment. Thus, there is a need to provide a seal for standard and non-standard flange designs where low compressive stresses and moderate to high system pressure exist.

One example of a prior art seal is U.S. Pat. No. 6,460,859 ('859) for “Resilient Elastomer and Metal Retainer Gasket for Sealing Between Curved Surfaces”, assigned to Parker-Hannifin Corporation, Cleveland, Ohio, herein incorporated by reference. The '859 patent relates to a gasket including a resilient retainer formed of a metal material and having an inner perimeter and an outer perimeter defining an enclosed geometric shape. At least one generally annular seal element is supported on the retainer to extend coaxially along at least a portion of the inner or outer perimeter thereof. Each of the seal members has oppositely-disposed first and second radial sealing surfaces configured for abutting, sealing contact with a corresponding one of the interfaces surfaces. With the gasket assembly being interposed between the interface surfaces, each of the seal elements is compressible axially. In such stressed state of the gasket assembly, and with one or more fluid-tight seals being effected between the interface surfaces, the retainer is made to curvably conform to the curvatures of the interface surfaces.

Seals such as the '859 seal require expensive tooling for each size. They further use an O-ring type (bulb) cross section, and are not re-buildable in the field. Additionally, the seal element portion of this seal is not contained on the inner diameter. This leaves the inner diameter of the seal element free to deform in whatever shape its environment causes.

Another example of a prior art seal is U.S. Pat. No. 4,776,600 ('600) for “Dielectric Pipe Flange Gasket”, assigned to Pikotek, Inc., Lakewood, Colo., herein incorporated by reference. The '600 patent relates to dielectric pipe flange gaskets comprising a planar annular disc member of corrosion resisting metal sandwiched between two hard dielectric planar members respectively bonded to two faces thereof and a pair of ring seals made of dielectric elastomer respectively disposed in two annular seal grooves respectively included in two faces of the pipe flange gasket, wherein the depth of the grooves partially extend into the metallic planar annular disc member.

The '600 gasket is designed specifically for electric isolation applications. The seal elements are not adhered in place and may be accidentally removed during installation. Furthermore, the dielectric facing may not prevent over compression of the seal elements and the small O-ring cross section may prevent users from obtaining a seal on less then perfect flange faces. Additionally, the dielectric face may be subject to creep relaxation.

Thus, the gaskets available in the prior art do not combine the advantages of initiating and maintaining a seal with very low compressive stresses, allowing the seal to be installed without the use of torque measuring devices, withstanding high pressure with very low compressive force, preventing twisting or binding of the seal element during installation, and the ability to be rebuilt in the field by simply removing the old seal elements and replacing them.

It is to these perceived needs that the present invention is directed.

### SUMMARY OF THE INVENTION

In a first aspect of the present invention, a seal assembly is provided comprising, a retainer comprising at least one sealing face comprising an annular groove formed therein, and a seal element comprising a retainer engaging side and a flange engaging side at least partially disposed within said retainer groove and securely affixed therein by an adhesive disposed between the retainer engaging side of the seal element and an interior portion of the groove.

In one aspect of the present invention, the retainer comprises opposite first and second flat surfaces with a central opening extending through the retainer perpendicular to the first and second flat surfaces. The opposing flat surfaces of the retainer are circular and the central opening extends through the center of the first and second flat surfaces.

In one embodiment of the present invention, the groove comprises a rectangular cross section. Optionally, the retainer may comprise a plurality of bolt holes extending through the thickness thereof. Further, the seal element preferably comprises an annular ring comprising a rectangular cross section.

In another embodiment of the present invention, the retainer further comprises a second face having a groove formed therein. A second seal element is disposed at least partially within the groove in the second face and affixed therein an adhesive. In a preferred embodiment of the present invention, the first and second grooves are equidistant from the central opening of the retainer on the opposing faces, and the total depth of the first and second grooves is less than the thickness of the retainer.

In another preferred embodiment of the present invention, the depth of the groove is less than the thickness of the seal element, and the width of the groove is greater than the width of the seal element. In a most preferred embodiment of the present invention, the volume of the groove is substantially equal to the volume of the seal element.

The retainer preferably comprises a rigid material selected from the group of stainless steel alloys, metal alloys, epoxies, structural plastics, and resin composites, and the seal element comprises an elastomeric material, such as rubber, or most preferably VITON®. The preferred adhesive for use in the present invention comprises a pressure sensitive adhesive.

In a second aspect of the present invention, a flange assembly is provided comprising the seal assembly of an embodiment of the present invention disposed between a first and second pipe flange and secured in position by a plurality of bolts extending through the first pipe flange, through the retainer and through the second pipe flange. In a preferred embodiment of the present invention the volume of the groove is at least as great as the volume of the seal element such that when the bolts are tightened the sealing surfaces of the first flange deform the seal element into the groove until the sealing surface of the first flange contacts the face of the retainer.

In an additional aspect of the present invention, a seal assembly is provided comprising, an annular retainer comprising first and second flat circular faces and a central aperture extending through the center of said faces to allow fluid to flow therethrough, said annular retainer further comprising an annular groove formed in the first circular face thereof between said central aperture and the radially outer edge of the retainer, said groove comprising a cross section including a width and a depth, and, an annular seal element disposed at least partially within said groove and comprising a cross section including a width and a thickness wherein the thickness of the seal element is greater than the depth of the groove, and the seal element is retained within the groove with an adhesive.

In yet another aspect of the present invention, a seal assembly is provided comprising, an annular retainer comprising first and second flat circular faces and a central aperture extending through the center of said faces to allow fluid to flow therethrough, said annular retainer further comprising a pair of annular grooves formed in the first and second circular faces between said central aperture and the radially outer edge of the retainer, said grooves comprising a cross section including a width and a depth, and a pair of annular seal elements disposed at least partially within said grooves and comprising cross sections including a width and a thickness wherein the thickness of the seal elements is greater than the depth of the grooves, and the seal elements are retained within the grooves with an adhesive.

An additional aspect of the present invention provides a method for rebuilding and reusing a seal assembly comprising, providing a seal assembly comprising a retainer having an annular groove formed in a first surface thereof, and an annular seal element disposed within said groove and secured therein with an adhesive, removing the seal element from the retainer, providing a new seal element, applying adhesive to at least one of the new seal element or the groove and inserting the new seal element at least partially within the groove such that the adhesive securely retains the new seal element within the groove.

In one embodiment of the present invention, the retainer further comprises a second surface opposite said first surface and central opening extending through the center of the first and second surfaces, and wherein said second surface comprises a groove of rectangular cross section with a second seal element disposed therein. Further, the volume of the groove is preferred to be substantially equal to the volume of the seal element.

In another embodiment of the present invention, the new seal element includes a pressure sensitive adhesive applied to one side thereof and further comprises a protective backing applied to the pressure sensitive adhesive that is removed prior to inserting the new seal element within the groove.

Features of a seal assembly of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

A seal assembly of the present invention provides numerous advantages over prior gaskets and seals. For example, the present invention advantageously provides the ability to initiate and maintain a seal with very low compressive stresses, allowing the seal to be installed without the use of torque measuring devices, while withstanding high pressure with very low compressive force, including means for preventing twisting or binding of the seal element during installation, and the ability to be rebuilt in the field by simply removing the old seal elements and replacing them.

As will be realized by those of skill in the art, many different embodiments of a seal assembly according to the present invention are possible. Additional uses, objects, advantages, and novel features of the invention are set forth in the detailed description that follows and will become more apparent to those skilled in the art upon examination of the following or by practice of the invention.

### BRIEF DESCRIPTION OF THE DRAWINGS

FIG. 1 is a front view of a seal assembly in an embodiment of the present invention.

FIG. 2 is a side view of seal assembly in an embodiment of the present invention.

FIG. 3 is a cross sectional view taken along the line I-I of FIG. 1 in an embodiment of the present invention.

FIG. 4 is a cross sectional exploded view of a retainer with one associated seal element in an embodiment of the present invention.

FIG. 5 is cross sectional view of a seal assembly positioned between two pipe flanges in an embodiment of the present invention.

FIG. 6 is a partial cross sectional view of a seal assembly showing various dimensions in an embodiment of the present invention.

FIG. 7 is a partial cross sectional view of a seal assembly positioned between two pipe flanges in an embodiment of the present invention.

FIG. 8 is a cross sectional view of a seal assembly comprising offset grooves in an embodiment of the present invention.

FIG. 9 is a cross sectional view of a seal assembly comprising two sets of grooves on either side of the retainer in an embodiment of the present invention.

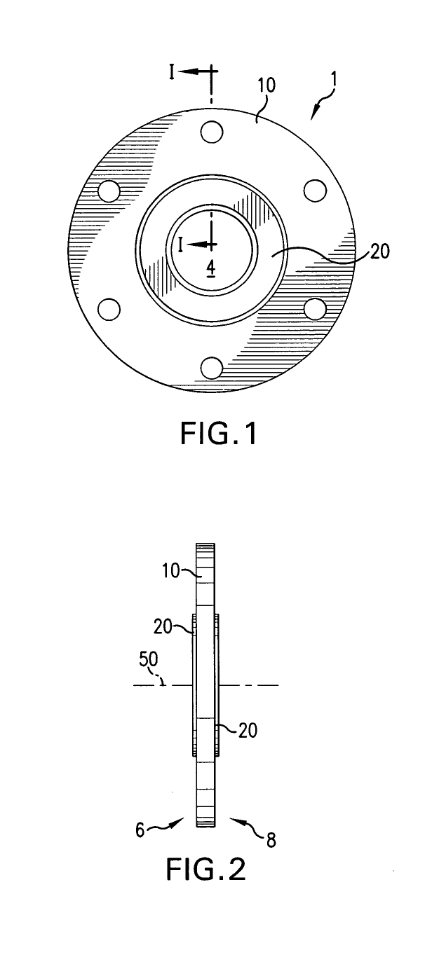

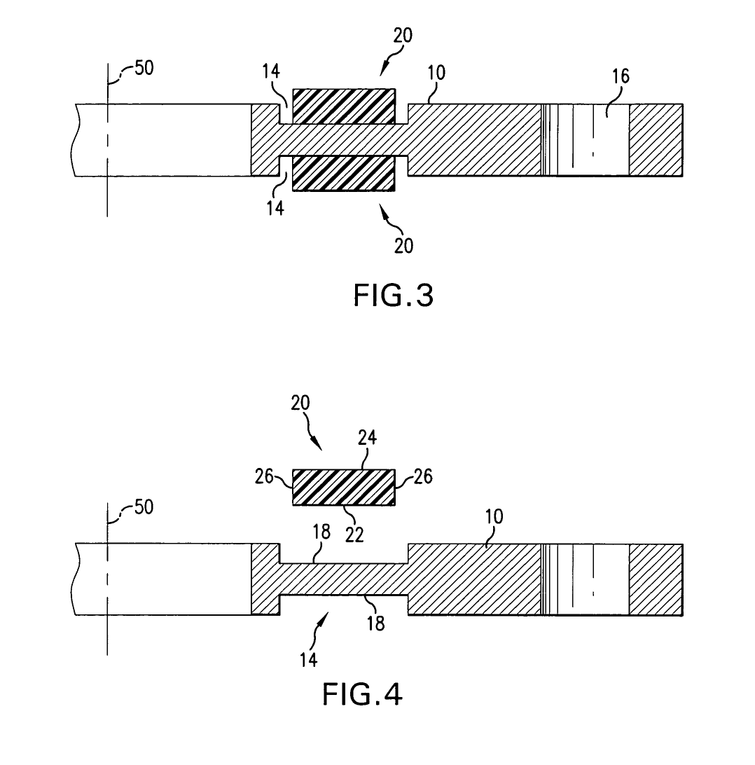

### DETAILED DESCRIPTION

In a first aspect of the present invention, a seal assembly is provided comprising a retainer comprising a first surface having an annular groove formed therein, and a seal element disposed within the groove and secured therein with an adhesive.

Referring now to the figures, the preferred embodiments of the present invention will be described. A dashed line 50 is used herein to designate the centerline of the fluid flow path. In one embodiment of the present invention, the retainer 10 comprises two flat opposing faces 6, 8 and a thickness therebetween. In a preferred embodiment of the present invention, the retainer is disk shaped with the two flat opposing faces comprising circles. An aperture 4 extends through the center of the retainer to allow fluid to pass therethrough. When the retainer is positioned between two pipe flanges, it is preferable to dimension the central aperture to correspond to the internal diameter of the pipe.

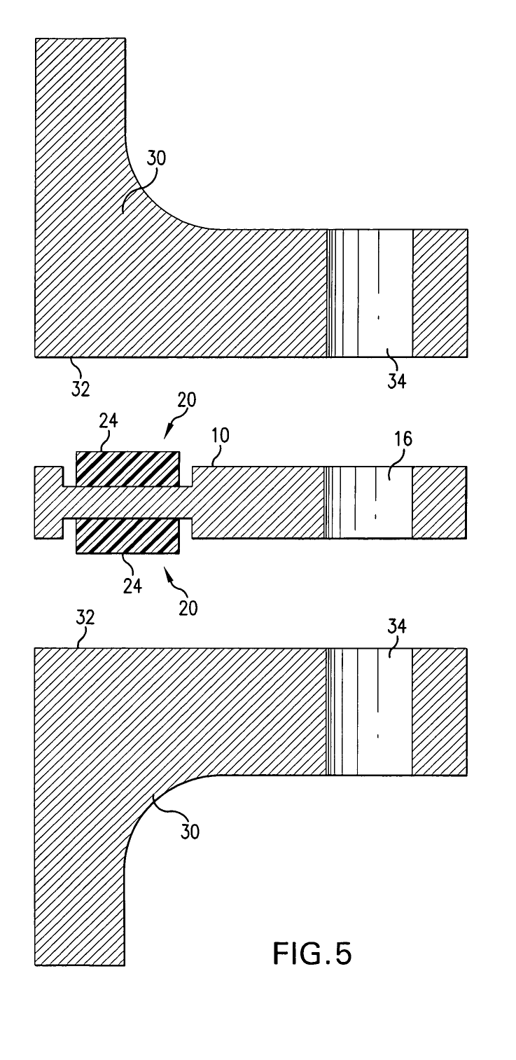

Referring to FIGS. 5 and 7, flanges 30 are often secured through the use of a plurality of bolts 36 passing through each flange with nuts 38 on either end to secure them together. In one embodiment of the present invention, the retainer is designed to reside completely within the perimeter of the plurality of bolts. In an alternate embodiment of the present invention, at least a portion of the retainer intersects said bolts. Tabs extending from the outer circumference of the retainer are provided with bolt holes therein for engaging said bolts therethrough and securing the retainer in position between the flanges. However, in a preferred embodiment of the present invention, illustrated in the figures, the retainer 10 is provided with a plurality of bolt holes 16 for directly accepting the flange bolts 36 therethrough.

In an additional embodiment of the present invention, the retainer 10 comprises an annular groove 14 formed on at least one of the faces 6, 8. The groove 14 is formed between the central aperture 4 and the radially outer circumference of the retainer so as to provide at least a portion of retainer material on both the radially inner and radially outer sides of the groove. The location of the groove 14 between the aperture 4 and the radially outer circumference of the seal may vary depending on flange configuration and other design parameters. The groove 14 is preferably machined into the retainer 10 after the retainer body is formed. However, in an alternate embodiment of the present invention, the groove is formed along with the retainer body as part of a molding process.

The geometric cross sectional profile of the groove will vary depending on the application and desired compressive characteristics of the seal assembly. Suitable shapes for the groove cross section include rectangular, rounded, oval, or trapezoidal. In a preferred embodiment of the present invention, the cross sectional shape of the groove is rectangular as is illustrated in the figures. A rectangular groove provides advantages during placement between pipe flanges and the mechanics the sealing apparatus.

In a preferred embodiment of the present invention, the retainer 10 comprises two grooves 14 on the opposing faces 6, 8 of the retainer. This configuration facilitates the mating of two flange faces 32 with a fluid path 50 defined therethrough. In an even more preferred embodiment of the present invention, the two grooves 14 are directly opposed one another such that they are equidistant from the center aperture and the radially outer edge of the retainer. In this manner, the stresses on the retainer are balanced and a uniform seal element size may be employed.

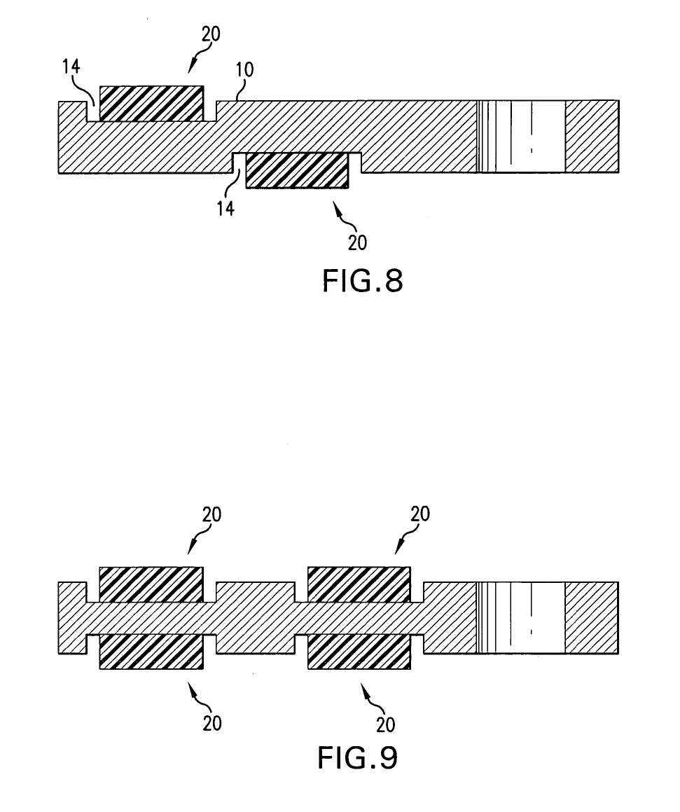

In another embodiment of the present invention, illustrated in FIG. 8, the grooves 14 and seal elements 20 are offset from one another on the opposing faces of the retainer. The grooves 14 are shown to be completely offset, but may be partially offset as well. In a further embodiment of the present invention, illustrated in FIG. 9, two sets of grooves 14 and seal elements 20 are provided on each of the opposing faces of the retainer. Other modifications and variations relating to the quantity and position of the grooves and seal elements will be apparent to one skilled in the art.

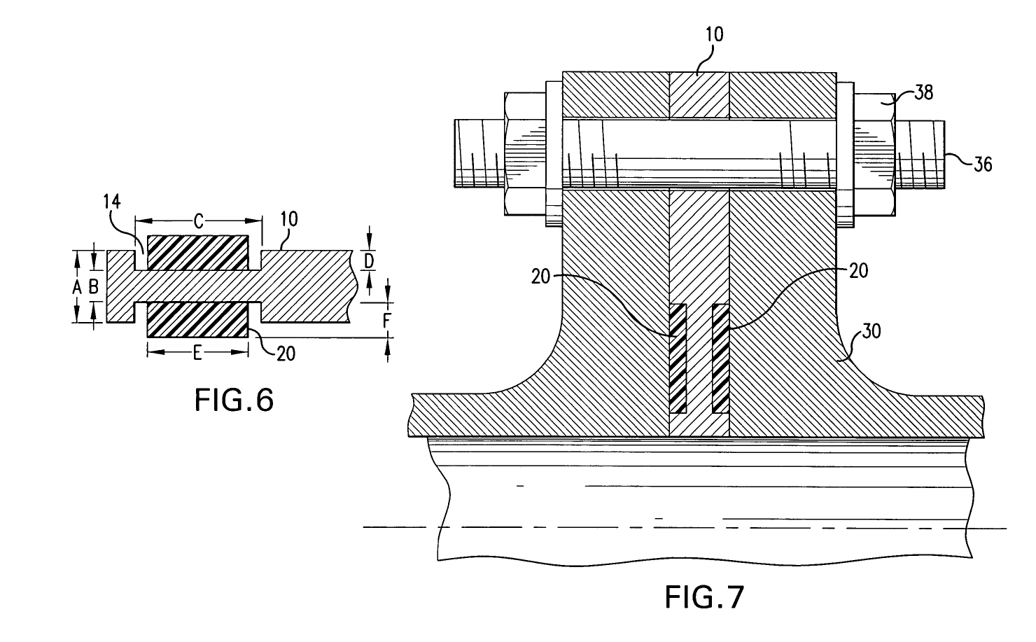

Referring now to FIG. 6, the depth of the groove D is primarily dependant upon the groove 14 and seal element 20 geometry as described herein and is dependant upon the desired compression of the seal element material. However, the groove is preferably less than half the thickness A of the retainer so as to provide sufficient retainer body so as to support and withstand the internal stresses of the seal. In the preferred embodiment of the present invention comprising a groove 14 on each face 6, 8 of the retainer, the total depth of the grooves 14 must be less than the total thickness of the retainer so as to provide some retainer material B between the rear portions of the grooves. In this embodiment of the present invention, the grooves extend from their respective faces D about one quarter of the thickness of the retainer A.

In a preferred embodiment of the present invention, the retainer 10 is constructed of a rigid material such as stainless steel alloys, metal alloys, epoxies, structural plastics, and resin composites. The retainer must be rigid enough to support the seal element and provide a means for limiting the compression of the retainer. The retainer also is required to withstand several normal use cycles comprising insertion into a flange assembly, removal of the retainer and discarding the used seal element, insertion of a new seal element into the retainer, and reinsertion into the flange assembly.

In one embodiment of the present invention, the seal element 20 comprises an annular strip of material shaped to fit at least partially within the groove 14 and compress or deform against the flange face 32 when the seal assembly is secured between two flange faces. In a preferred embodiment of the present invention, the seal element 20 is at least slightly thicker in cross section than the groove is in depth. As illustrated in FIG. 6, F is greater than D. This allows the seal element to protrude at least slightly from the top of the groove and past the surface of the retainer face. In this position, the seal element will contact the flange face first when the flange bolts are tightened.

In a further preferred embodiment of the present invention, the seal element 20 comprises a rectangular cross section. The width of the cross section of the seal element 20 is preferably less than the width of the groove 14. As illustrated in FIG. 6, E is less than C. This allows for some play between the groove wall and the seal element, thereby facilitating construction of the seal assembly and allowing space to accommodate deterioration of the seal element 20 when the flange contacts the seal element and exerts force thereon. To enhance the contact between the retainer 10, seal 20 and flange face 32, the retainer engaging side of the seal element 22, and the flange engaging side of the seal element 24 are preferably flat and substantially parallel to one another. However, in an alternate embodiment of the present invention, the cross section of the seal element may comprise a circle, rectangle, diamond, trapezoid, or any other standard geometric shape known in the art.

In one embodiment of the present invention, the seal element comprises an elastomeric compound such as rubber. In a preferred embodiment of the present invention, the seal element comprises a fluoroeleastomer, such as VITON®. Other suitable materials include silicone, neoprene, PTFE, fiber sheet, graphite, or any other known gasketing material. In another preferred embodiment of the present invention, the seal element comprises a material which is compressible and/or deformable under stresses which will not compress or deform the retainer.

In a preferred embodiment of the present invention, the cross sectional area of the seal element is less than or equal to the cross sectional area of the groove. As illustrated in FIG. 6, the product of (E×F) is less than or equal to the product of (C×D). In this manner, a non-compressible but deformable seal element is deformed into the area of the groove when the portion of the seal element normally extending out of the groove is forced into the groove by an approaching flange face. In this embodiment the groove and seal element must be sized appropriately to allow for deformation of the seal element within the groove. By constructing the cross sectional width of the seal element to be less than the cross sectional width of the groove, the seal element, when compressed, will deform and at least partially fill the extra space within the groove.

In an embodiment of the present invention, the seal element is securely held in position at least partially within the groove with an adhesive. Preferred adhesives include pressure sensitive adhesives, spray adhesives, epoxies, or the like. The adhesive is preferably disposed between the bottom surface of the groove 18 and retainer engaging side of the seal element 22. The adhesive may be applied throughout the bottom surface of the groove 18, or optionally, applied at one or more points throughout the circumference of the groove.

The primary purpose of the adhesive is to secure the seal element 20 within the groove 14 during installation of the seal assembly 1 between two flanges 30. Thus, the adhesive need not be permanent or exceptionally strong. Once the seal assembly 1 is disposed between the flanges 30, the force of the flanges on the seal element and retainer will secure all elements in position. In a preferred embodiment of the present invention, the adhesive, while securing the seal element during assembly, will allow the seal element to deform upon compression by a flange surface.

In a preferred embodiment of the present invention, the adhesive provides a means for securing the seal element within the groove during assembly, however allows the seal element to be removed by a technician without the use of solvents or tools. In this manner the seal element is replaceable and the retainer reusable. At the end of the useful life of the seal element, the flange assembly is unbolted and the seal assembly is removed from between the flanges. Then the seal element is removed from the groove and a new seal element is positioned within the groove with new adhesive to secure it in place. In this manner, the retainer is reusable.

In a preferred embodiment of the present invention, the seal element is adhered within the groove using a pressure sensitive adhesive applied to the seal element along with a protective backing. The pressure sensitive adhesive with paper backing is affixed to the seal element. Before inserting the seal element into the groove, the backing is removed and the pressure sensitive adhesive is exposed. The seal element is then positioned into the groove and pressed into place with the pressure sensitive adhesive contacting and adhering to the innermost surface of the groove. In this manner, the seal element, complete with adhesive may be stored and transported prior to installation, thereby facilitating the rebuildable nature of the seal assembly of the present invention.

In a preferred embodiment of the present invention, the preferred intended use of the seal assembly is for sealing the area between two flanges in a pipe system, as illustrated in FIGS. 5 and 7. Flanges 30 are commonly secured with a series of bolts 36 around their perimeter. As the bolts 36 are tightened, the flanges 30 come together thereby compressing the seal element 20, which is protruding at least partially from the groove 14 in the retainer 10. As the flanges continue to move toward each other, the seal element continues to compress until the flanges 30 contact the opposing faces 6, 8 of the retainer. The retainer 10 acts as a compression limiter preventing further compression of the seal element 20, and an effective seal is thereby created.

Construction of the retainer with a rigid material will prevent deformation or compression of the retainer, thus when the flange surfaces 32 meet the retainer faces 6, 8 the seal element will be adequately compressed within the groove. By limiting compression of the seal element, damage to the element associated with over-tightening of the flange bolts and over compression of the seal element can be avoided. This allows a predetermined compression of the seal element without the use of torque measuring devices. Additionally, the seal element and grooves can be formed so as to precisely predict the compression or deformation of the seal element and the forces acting thereon. This will further enhance the sealing characteristics of the assembly.

In a further embodiment of the present invention, the groove in the retainer comprises the added feature of providing axial support for the seal element during operation. Once the seal assembly is secured between the flange faces, the seal is compressed or deformed into the groove on the retainer. Thus, any radially outward force on the seal element due to pressure within the flange assembly will be counteracted at least partially by the radially outer wall of the groove. This further enhances the sealing characteristics of the assembly by preventing movement or distortion of the seal element caused by the internal pressures.

The arrangement of the present invention also provides reliability of alignment of the seal during installation. With the seal element securely held within the groove by the adhesive, the assembly can be positioned within the space between two flanges without twisting or distortion of the seal element. This provides a better seal by ensuring uniform contact between the seal element and the flange face. Further, the configurations of the embodiments of the present invention provide a seal that is easily installed and removed from the flanges. Additionally, the seal element can be removed and replaced with a new seal element allowing the retainer to be reusable.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

What is claimed is:

1. A seal assembly comprising:
a retainer comprising at least one sealing face comprising an annular groove formed therein; and,
a seal element comprising a retainer engaging side and a flange engaging side at least partially disposed within said retainer groove and securely affixed therein by an adhesive disposed between the retainer engaging side of the seal element and an interior portion of the groove.

2. The seal assembly of claim 1, wherein the retainer comprises opposite first and second flat surfaces with a central opening extending through the retainer perpendicular to the first and second flat surfaces.

3. The seal assembly of claim 2, wherein the opposing flat surfaces of the retainer are circular and the central opening extends through the center of the first and second flat surfaces.

4. The seal assembly of claim 1, wherein the groove comprises a rectangular cross section.

5. The seal assembly of claim 1, wherein the retainer further comprises a plurality of bolt holes extending through the thickness thereof.

6. The seal assembly of claim 1, wherein the seal element comprises an annular ring comprising a rectangular cross section.

7. The seal assembly of claim 1, wherein the retainer further comprises a second face having a groove formed therein.

8. The seal assembly of claim 7, further comprising a second seal element disposed at least partially within the groove in the second face and affixed therein an adhesive.

9. The seal assembly of claim 7, wherein the first and second grooves are equidistant from the central opening of the retainer on the opposing faces.

10. The seal assembly of claim 7, wherein the total depth of the first and second grooves is less than the thickness of the retainer.

11. The seal assembly of claim 1, wherein the depth of the groove is less than the thickness of the seal element.

12. The seal assembly of claim 1, wherein the width of the groove is greater than the width of the seal element.

13. The seal assembly of claim 1, wherein the volume of the groove is substantially equal to the volume of the seal element.

14. The seal assembly of claim 1, wherein the retainer comprises a rigid material selected from the group of stainless steel alloys, metal alloys, epoxies, structural plastics, and resin composites.

15. The seal assembly of claim 1, wherein the seal element comprises an elastomeric material.

16. The seal assembly of claim 15, wherein the seal element comprises rubber.

17. The seal assembly of claim 1, wherein the seal element comprises compressible polytetrafluoroethylene.

18. The seal assembly of claim 1, wherein the adhesive comprises a pressure sensitive adhesive.

19. A flange assembly comprising the seal assembly of claim 1, disposed between a first and second pipe flange and secured in position by a plurality of bolts extending through the first pipe flange, through the retainer and through the second pipe flange.

20. The flange assembly of claim 19, wherein the volume of the groove is at least as great as the volume of the seal element such that when the bolts are tightened the sealing surfaces of the first flange deform the seal element into the groove until the sealing surface of the first flange contacts the face of the retainer.

21. A seal assembly comprising:
an annular retainer comprising first and second flat circular faces and a central aperture extending through the center of said faces to allow fluid to flow therethrough, said annular retainer further comprising an annular groove formed in the first circular face thereof between said central aperture and the radially outer edge of the retainer, said groove comprising a cross section including a width and a depth; and,
an annular seal element disposed at least partially within said groove and comprising a cross section including a width and a thickness;
wherein the thickness of the seal element is greater than the depth of the groove, and the seal element is retained within the groove with an adhesive.

22. A seal assembly comprising:
an annular retainer comprising first and second flat circular faces and a central aperture extending through the center of said faces to allow fluid to flow therethrough, said annular retainer further comprising a pair of annular grooves formed in the first and second circular faces between said central aperture and the radially outer edge of the retainer, said grooves comprising a cross section including a width and a depth; and,
a pair of annular seal elements disposed at least partially within said grooves and comprising cross sections including a width and a thickness;
wherein the thickness of the seal elements is greater than the depth of the grooves, and the seal elements are retained within the grooves with an adhesive.

23. A method for rebuilding and reusing a seal assembly comprising:
a) providing a seal assembly comprising a retainer having an annular groove formed in a first surface thereof, and an annular seal element disposed within said groove and secured therein with an adhesive,
b) removing the seal element from the retainer;
c) providing a new seal element;
d) applying adhesive to at least one of the new seal element or the groove; and
e) inserting the new seal element at least partially within the groove such that the adhesive securely retains the new seal element within the groove.

24. The method of claim 23, wherein the retainer of step (a) further comprises a second surface opposite said first surface and central opening extending through the center of the first and second surfaces, and wherein said second surface comprises a groove of rectangular cross section with a second seal element disposed therein.

25. The method of claim 24, wherein steps (b) through (e) are performed on the second seal element within the second groove.

26. The method of claim 23, wherein steps (c) and (d) comprise providing a new seal element including a pressure sensitive adhesive applied to one side thereof.

27. The method of claim 26, wherein the new seal element further comprises a protective backing applied to the pressure sensitive adhesive that is removed prior to inserting the new seal element within the groove.

28. The method of claim 23 wherein the volume of the groove is substantially equal to the volume of the seal element.
